(19) United States
(12) Patent Application Publication
(10) Pub. No.: US 2024/0367551 A1
(43) Pub. Date: Nov. 7, 2024

(54) ALTERNATING CURRENT HEATING FOR A PARALLEL CONNECTED MIXED CHEMISTRY BATTERY PACK

(71) Applicant: GM Global Technology Operations LLC, Detroit, MI (US)

(72) Inventors: Shuonan Xu, Troy, MI (US); Lei Hao, Troy, MI (US); Neeraj S. Shidore, Novi, MI (US); Hanho Yun, Oakland Township, MI (US)

(21) Appl. No.: 18/310,725

(22) Filed: May 2, 2023

(51) Int. Cl. B60L 58/27; B60L 50/64; H01M 10/615

(52) U.S. Cl. CPC B60L 58/27; B60L 50/64; H01M 10/615; B60L 2210/10; H01M 2220/20

(57) ABSTRACT

A vehicle and a system performing a method of heating a battery of the vehicle. The vehicle includes a battery having a first cell having a first cell type and a second cell having a second cell type, a DC/DC converter having a first side and a second side, and a processor that controls flow of current. The first cell is connected to a first side of a DC/DC converter and the second cell is connected to the second side of the DC/DC converter. A first current is flowed between the first cell and the second through the DC/DC converter to heat the first cell and the second cell during a first heating phase. A second current is flowed between the second cell and the DC/DC converter to heat the second cell during a second heating phase.

### INTRODUCTION

The subject disclosure relates to operation of battery cells in a battery pack of an electric vehicle and, in particular, to a system and method of heating the battery cells by sharing electrical energy between the cells.

Electric vehicles include electric motors that run off electric power provided by electrical power sources such as a battery pack. A battery pack includes multiple battery cells, many of which can have different compositions and have different power characteristics. Each battery cell includes an optimal temperature range for operation. Operating a battery cell at a temperature below the optimal operating temperature range can decrease the life of the battery. Unfortunately, the temperature of the battery tends to reach equilibrium with the ambient temperature, which can be less than the optimal temperature range, especially on cold days. Accordingly, it is desirable to provide a system and method for heating a battery cell.

### SUMMARY

In one exemplary embodiment, a method of heating a battery of a vehicle is disclosed. A first cell of the battery is connected to a first side of a direct current converter (DC/DC converter). A second cell of the battery is connected to a second side of the DC/DC converter. A first current is flowed between the first cell and the second cell through the DC/DC converter to heat the first cell and the second cell during a first heating phase. A second current is flowed between the second cell and the DC/DC converter to heat the second cell during a second heating phase.

In addition to one or more of the features described herein, the DC/DC converter generates an alternating current to heat the first cell and the second cell. A first heating rate of the first cell is greater than a second heating rate of the second cell. The method further includes selecting a magnitude of the first current based on the first heating rate. The method further includes switching from the first heating phase to the second heating phase when a first temperature of the first cell rises to a target temperature. The method further includes operating the vehicle in one of a propulsion mode and a heating mode, wherein the DC/DC converter connects the second cell to a motor of the vehicle in the propulsion mode and connects the second cell to the first cell in the heating mode. The method further includes operating the motor off of the first cell in both the propulsion mode and the heating mode.

In another exemplary embodiment, a system for heating a battery of a vehicle is disclosed. The system includes a first cell having a first cell type, a second cell having a second cell type, a direct current converter (DC/DC converter) having a first side coupled to the first cell and a second side coupled to the second cell, and a processor. The processor is configured to control flow of a first current between the first cell and the second cell through the DC/DC converter to heat the first cell and the second cell during a first heating phase and control flow of a second current between the second cell and the DC/DC converter to heat the second cell during a second heating phase.

In addition to one or more of the features described herein, the DC/DC converter generates an alternating current to heat the first cell and the second cell. A first heating rate of the first cell is greater than a second heating rate of the second cell. The processor is further configured to select a magnitude of the first current based on the first heating rate. The processor is further configured to switch from the first heating phase to the second heating phase when a first temperature of the first cell rises to a target temperature. The processor is further configured to operate the vehicle in one of a propulsion mode and a heating mode, wherein the DC/DC converter couples the second cell to a motor of the vehicle in the propulsion mode and couples the second cell to the first cell in the heating mode. The processor is further configured to operate the motor off of the first cell in both the propulsion mode and the heating mode.

In another exemplary embodiment, a vehicle is disclosed. The vehicle includes a battery having a first cell having a first cell type and a second cell having a second cell type, a direct current converter (DC/DC converter) having a first side coupled to the first cell and a second side coupled to the second cell, and a processor. The processor is configured to control flow of a first current between the first cell and the second cell through the DC/DC converter to heat the first cell and the second cell during a first heating phase and control flow of a second current between the second cell and the DC/DC converter to heat the second cell during a second heating phase.

In addition to one or more of the features described herein, the DC/DC converter generates an alternating current to heat the first cell and the second cell. A first heating rate of the first cell is greater than a second heating rate of the second cell. The processor is further configured to select a magnitude of the first current based on the first heating rate. The processor is further configured to switch from the first heating phase to the second heating phase when a first temperature of the first cell rises to a target temperature. The processor is further configured to operate the vehicle in one of a propulsion mode and a heating mode, wherein the DC/DC converter couples the second cell to a motor of the vehicle in the propulsion mode and couples the second cell to the first cell in the heating mode.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 shows a schematic view of a battery pack;

FIG. 3 shows an energy transfer circuit for cells of the battery pack;

FIG. 4 shows a graph illustrating heating for a first cell and a second cell using the heating methods disclosed herein;

FIG. 5 shows a flowchart of a method for heating the battery pack, in an illustrative embodiment;

FIG. 6 shows a detailed circuit diagram of the energy transfer circuit of FIG. 3;

FIG. 7 shows a schematic diagram of the DC/DC converter in a first embodiment;

FIG. 8 shows a schematic diagram of the DC/DC converter in a second embodiment;

FIG. 9 shows a diagram indicating use of the first cell and second cell to operate a motor in a propulsion mode; and

FIG. 10 shows a diagram indicating operation of the motor in a heating mode.

### DETAILED DESCRIPTION

The following description is merely exemplary in nature and is not intended to limit the present disclosure, its application or uses. It should be understood that throughout the drawings, corresponding reference numerals indicate like or corresponding parts and features.

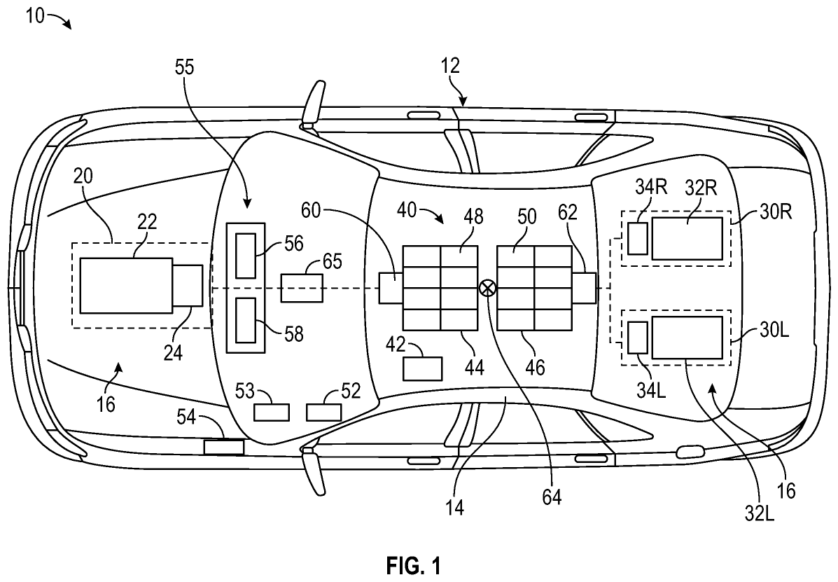

In accordance with an exemplary embodiment, FIG. 1 shows a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes an electric motor 32L and an inverter 34L. A right rear drive unit 30R includes an electric motor 32R and an inverter 34R. The inverters 24, 34L and 34R (e.g., power inverter units or PIMs) each convert DC power from a high voltage (HV) battery system 40 to poly-phase (e.g., two-phase, three-phase, six-phase, etc.) alternating current (AC) power to drive the front electric motor 22 and rear electric motors 32L and 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives front wheels (not shown) and the rear electric motors 32L and 32R drive rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems.

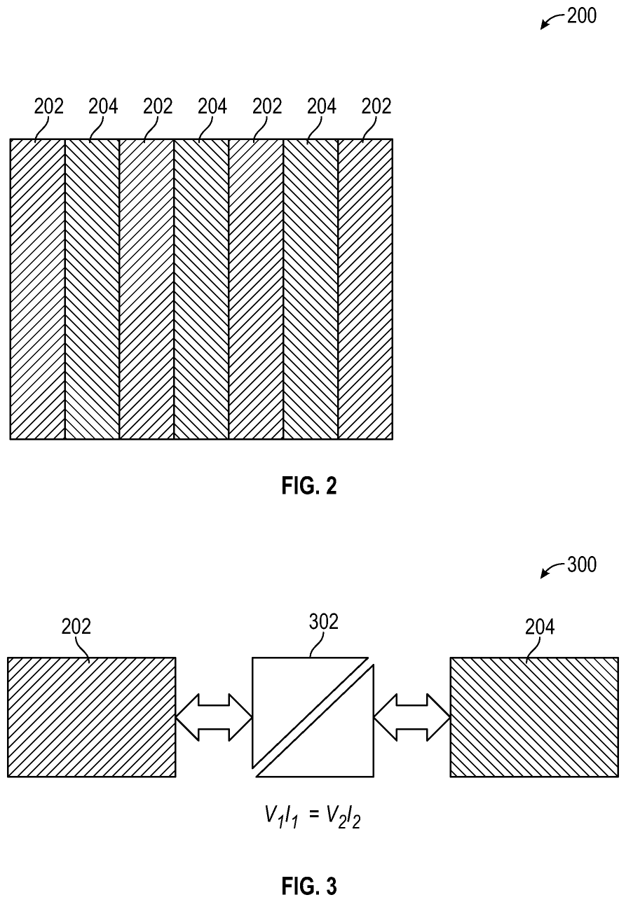

For example, the battery system 40 includes a first battery assembly such as a first battery sub-pack 44 connected to the front inverter 24, and a second battery sub-pack 46. The first battery sub-pack 44 includes a plurality of battery modules 48, and the second battery sub-pack 46 includes a plurality of battery modules 50. Each battery module 48, 50 includes a number of individual cells (not shown). In various embodiments, one or more of the battery packs can include a MODACS (Multiple Output Dynamically Adjustable Capacity) battery, as described herein with respect to FIGS. 2-4.

Each of the front electric motor 22 and the rear electric motors 32L and 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the battery packs 44 and 46, and selectively connecting the battery packs 44 and 46 to the front drive unit 20, left rear drive unit 30L and right rear drive unit 30R. The switching devices may also be operated to selectively connect the first battery sub-pack 44 and the second battery sub-pack 46 to a charging system. The charging system can be used to charge the first battery sub-pack 44 and the second battery sub-pack 46, and/or to supply power from the first battery sub-pack 44 and/or the second battery sub-pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC).

In an embodiment, the switching system includes a first switching device 60 that selectively connects the first battery sub-pack 44 to the inverters 24, 34L and 34R, and a second switching device 62 that selectively connects the second battery sub-pack 46 to the inverters 24, 34L and 34R. The switching system also includes a third switching device 64 (also referred to as a “battery switching device”) for selectively connecting the first battery sub-pack 44 to the second battery sub-pack 46 in series.

Any of various controllers can be used to control functions of the battery system 40, the switching system and the drive units. A controller includes any suitable processing device or unit and may use an existing controller such as a drive system controller, an RESS controller, and/or controllers in the drive system. For example, a controller 65 may be included for controlling switching and drive control operations as discussed herein.

The controller 65 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 65 may include a non-transitory computer-readable medium that stores instructions which, when processed by one or more processors of the controller 65, implement a method of heating a battery pack, according to one or more embodiments detailed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

FIG. 2 shows a schematic view 200 of a battery pack. The schematic view 200 shows multiple battery cells within the battery pack. For illustrative purpose, the battery pack includes a first cell 202 that is a first cell type and a second cell 204 that is a second cell type. The first cell 202 and the second cell 204 are interleaved with each other forming an alternating pattern. The first cell 202 can be a cell having a first chemical composition or cell characteristics while the second cell 204 can be a cell having a second chemical composition or cell characteristics. Thus, the operational specifications of the first cell 202 and the second cell 204 are different from each other. Due to differences in mass and specified heats, each cell type heats at different heating rates and can output different voltage levels. Since the cells are interleaved with each other, heat generated at one cell (e.g., first cell 202) can be received through conduction at an adjacent cell (e.g., second cell 204), thereby tending to equalize the heating rates.

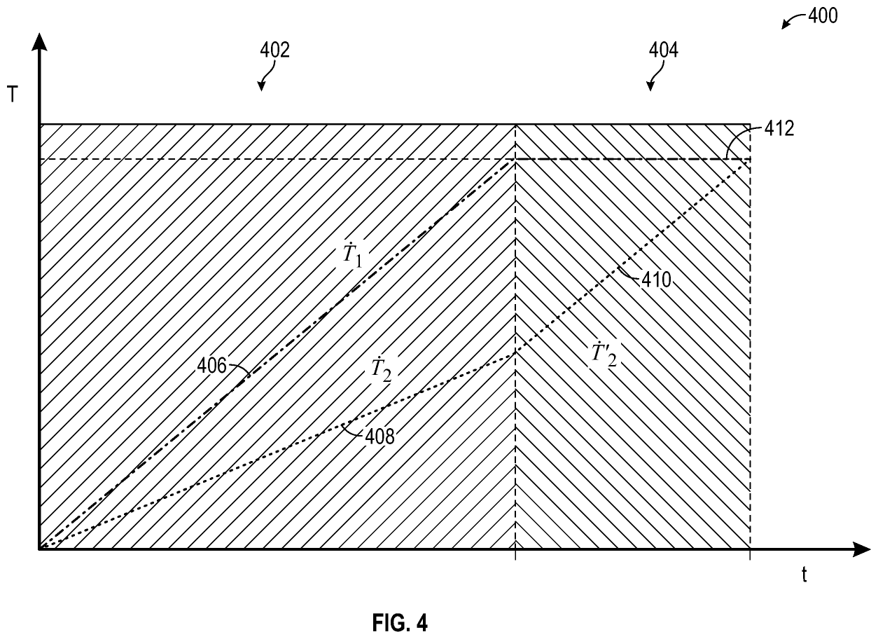

FIG. 3 shows an energy transfer circuit 300 for cells of the battery pack. The first cell 202 is coupled to a first side of a DC/DC converter 302 and the second cell 204 is coupled to a second side of the DC/DC converter. The first cell 202 generates an alternating current that flows through the DC/DC converter 302 and heats the first cell. In response to the first current, the DC/DC converter 302 induces a second current that flows through the second cell 204 to heat the second cell. This method can also be performed in the other direction with the second cell 204 generating the second current and the first current being induced in the first cell 202 by the DC/DC converter 302.

An energy balance at the DC/DC converter 302 is shown in Eq. (1).

$${V}_{1} {I}_{1} = {V}_{2} {I}_{2} \qquad Eq . ( 1 )$$

where V₁ and I₁ are the voltage and current of the first cell 202, respectively and V₂ and I₂ are the voltage and current of the second cell 204, respectively. A heating rate for each cell is dependent on the amount of current, the resistance of the cell, the mass of the cell and the specific heat of the cell. For the first cell, the first heating rate is shown in Eq. (2):

$${\dot{T}}_{1} = \frac{{I}_{1}^{2} {R}_{1}}{{m}_{1} {C}_{p 1}} \qquad Eq . ( 2 )$$

where I₁ is the root mean squared (RMS) current through the first cell, R₁ is the resistance of the first cell, m₁ is the mass of the first cell and Cₚ₁ is the specific heat of the first cell. Similarly, the second heating rate for the second cell is given in Eq. (3):

$${\dot{T}}_{2} = \frac{{I}_{2}^{2} {R}_{2}}{{m}_{2} {C}_{p 2}} \qquad Eq . ( 3 )$$

where I₂ is the RMS current through the second cell, R₂ is the resistance of the second cell, m₂ is the mass of the second cell and Cₚ₂ is the specific heat of the second cell. Combining Eqs. (1), (2) and (3) gives a relation between the heating rates of the first cell and second cell based on their physical properties, as shown in Eq. (4):

$${\dot{T}}_{2} = {\dot{T}}_{1} \cdot \frac{{m}_{1}}{{m}_{2}} \cdot \frac{{C}_{p 1}}{{C}_{p 2}} \cdot \frac{{V}_{1}^{2}}{{V}_{2}^{2}} \cdot \frac{{R}_{2}}{{R}_{1}} \qquad Eq . ( 4 )$$

From Eq. (4), the heating rates of the first cell and the second cell are generally different from each other. (e.g., T̅₁≠T̅₂).

FIG. 4 shows a graph 400 illustrating heating for a first cell and a second cell using the heating methods disclosed herein. Time is shown along the abscissa and temperature is shown along the ordinate axis. Heating occurs in a first heating phase 402 and a second heating phase 404. The first heating phase 402 is a mutual heating phase in which energy is transferred back and forth between the first cell 202 and the second cell 204. The second heating phase 404 is a dedicated heating phase, or individual heating phase, in which a cell self-heats until a target temperature 412 is reached, as discussed herein.

During the first heating phase 402, both cells are heated. A first line 406 represents a first temperature T₁ of the first cell during the first heating phase 402, and a second line 408 represents a second temperature T₂ of the second cell 204 during the second heating phase 404. For illustrative purposes, the heating rate T₁ of the first cell (i.e., the slope of first line 406) is greater than the heating rate T₂ of the second cell (i.e., the slope of the second line 408). A desired first heating rate for the first cell can be determined and an AC current can be selected using the Eq. (2) that produces the desired heating rate. The first heating phase 402 is ended once a temperature T₁ of the first cell 202 reaches or rises to a target temperature T_{target}. The target temperature can be selected by a user or processor prior to commencing the heating process.

The second heating phase 404 commences at the end of the first heating phase 402. At the end of the first heating phase 402, the remaining battery (e.g., the second cell 204) is not yet at the target temperature. The second heating phase 404 involves having the remaining battery heat itself. Line 410 represents the second temperature T₂ of the second battery during the second phase 404. The heating rate T̅′₂ of the second cell 204 during individual heating is different than the heating rate T̅₂ for the second cell during mutual heating. Generally, the heating rate of the second cell 204 increases during the single-phase heating.

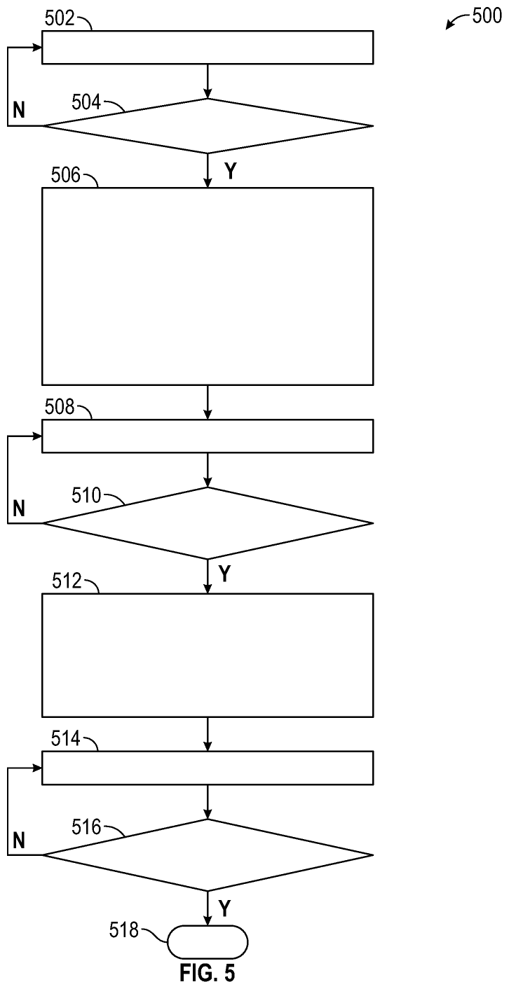

FIG. 5 shows a flowchart 500 of a method for heating the battery pack, in an illustrative embodiment. In box 502, a temperature of the battery pack is measured. In box 504, a decision is made whether or not heating is needed. The decision can be based on a comparison of the temperature of the battery pack to a temperature range or target temperature. If the temperature of the battery pack is equal to or greater than the target temperature, no heating is need and the method returns to box 502. If the temperature of the battery pack is less than the target temperature, the method proceeds to box 506. In box 506, a heating current is determined. A magnitude of the first heating current I₁ for the first cell can be determined using Eq. (2). The first heating current I₁ is dependent on the heating rate that is desired. The heating rate can be a selected, such as 0.5 degree/minute, 1 degree/minute, etc. An upper bound to the first heating rate is presented by an upper bound to the first heating current that can be supported in the circuit. The second heating current I₂ for the second cell can be determined from the first heating current I₁ and Eq. (1).

In box 508, the heating is performed using the mutual heating of the first phase. In box 510, the temperature T₁ of the first cell is monitored and compared to the target temperature. While the temperature T₁ has not reached the target temperature (i.e., while T₁ is less than then target temperature), the method returns to box 508. Once the temperature T₁ reaches the target temperature, the method proceeds to box 512.

In box 512, a second heating current is determined for the second cell for a second heating phase. The second heating current I₂′ can be determined by selecting a second heating rate and using Eq. (3). In box 514, heating is performed using the individual heating of the second phase. In box 516, the temperature T₂ of the second cell is monitored and compared to the target temperature. While the temperature T₂ has not reached the target temperature (i.e., T₂ is less than then target temperature), the method returns to box 514. Once the temperature T₂ reaches the target temperature, the method proceeds to box 518. At box 518, the process ends.

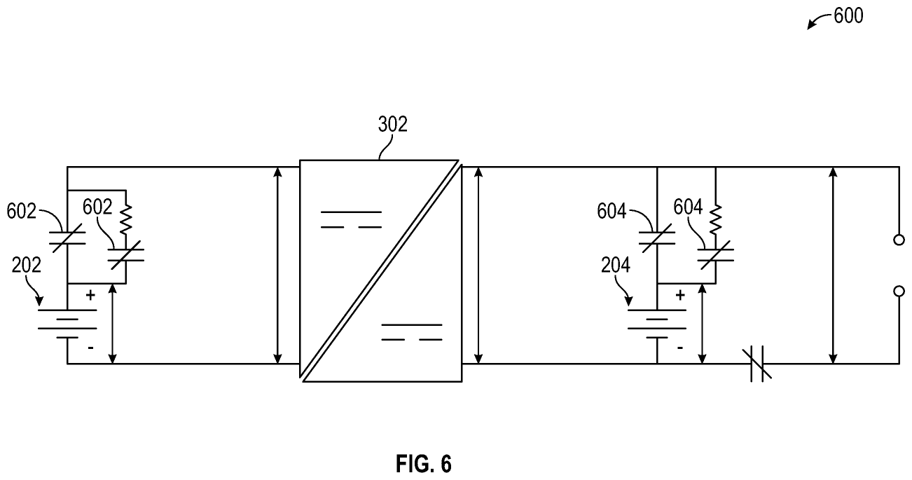

FIG. 6 shows a detailed circuit diagram 600 of the energy transfer circuit 300 of FIG. 3. The first cell 202 is electrically coupled to a primary side of the DC/DC converter 302. The second cell 204 is coupled to a secondary side of the DC/DC converter 302. A first set of contactors 602 can be configured to open or close a connection between the first cell 202 and the DC/DC converter 302. A second set of contactors 604 can be configured to open or close a connection between the second cell 204 and the DC/DC converter 302.

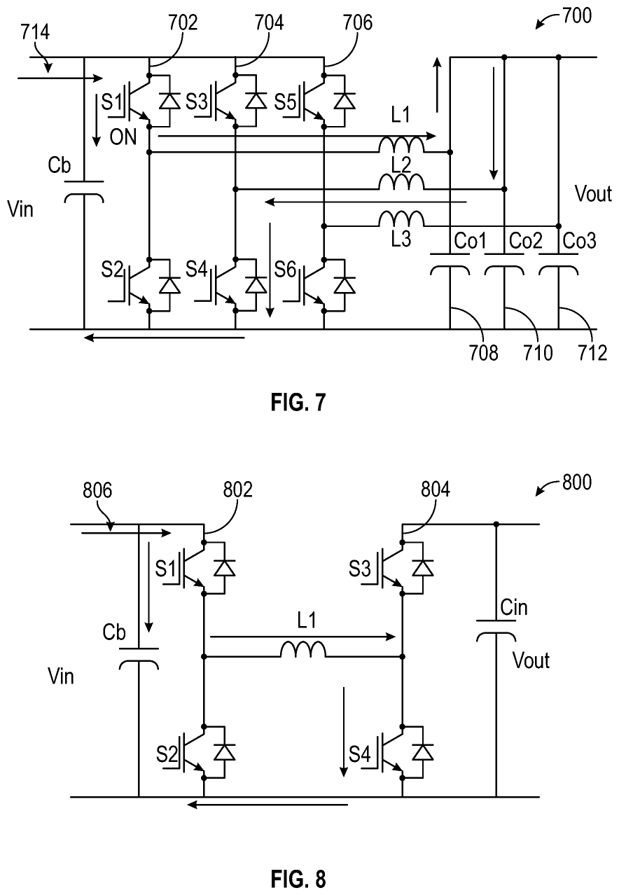

FIG. 7 shows a schematic diagram 700 of the DC/DC converter 302 in a first embodiment. The DC/DC converter 302 is a multiphase bi-directional converter including a plurality of branches of field effect transistors (FETs) at the primary side of the DC/DC converter. In particular, the DC/DC converter 302 includes first branch 702 with switches S1 and S2, second branch 704 with switches S3 and S4, and third branch 706 with switches S5 and S6. Each of the first branch 702, second branch 704 and third branch 706 can conduct current to and from a respective first capacitive branch 708, second capacitive branch 710, and third capacitive branch 712 (on a secondary side) via a respective first inductor L1, second inductor L2 and third inductor L3, thereby generating an alternating current in the process. The AC current is rectified at the secondary side to a DC current. The AC current generates heat that raises the temperatures of the cells. The DC/DC can thereby shuttle energy back and forth between the first cell and the second cell at a desired AC heating frequency during the first heating phase 402.

During the second heating phase 404, the switches of the DC/DC converter can be configured to circulate only through one cell (e.g., the first cell). As illustrated in FIG. 7, during the second heating phase 404, switches S1 and S4 are turned off, while switches S2, S3, S5 and S6 are turned off to create a circuit that includes passes through the first inductor L1 and the second inductor L2, creating a current loop 714 that returns to one side (i.e., the primary side) of the DC/DC converter.

FIG. 8 shows a schematic diagram 800 of the DC/DC converter 302 in a second embodiment. The DC/DC converter is a single-phase converter includes a first branch 802 of field effect transistors (FETs) at the primary side of the DC/DC converter and a second branch 804 of FETs at the secondary side. The first branch 802 includes switches S1 and S2 and the second branch 804 includes switches S3 and S4. A midpoint between switches S1 and S2 is connected to a midpoint between switches S3 and S4 via inductor L1. The converter can be used to conduct AC current between cells to generate heat which is rectified at the secondary side, thereby generating heat during the first heating phase 420. As illustrated in FIG. 8, during the second heating phase 404, switches S1 and S4 can be turned on and switches S2 and S3 can be turned off to create a current loop 806 that flows along only a single side (i.e., the primary side) of the DC/DC converter.

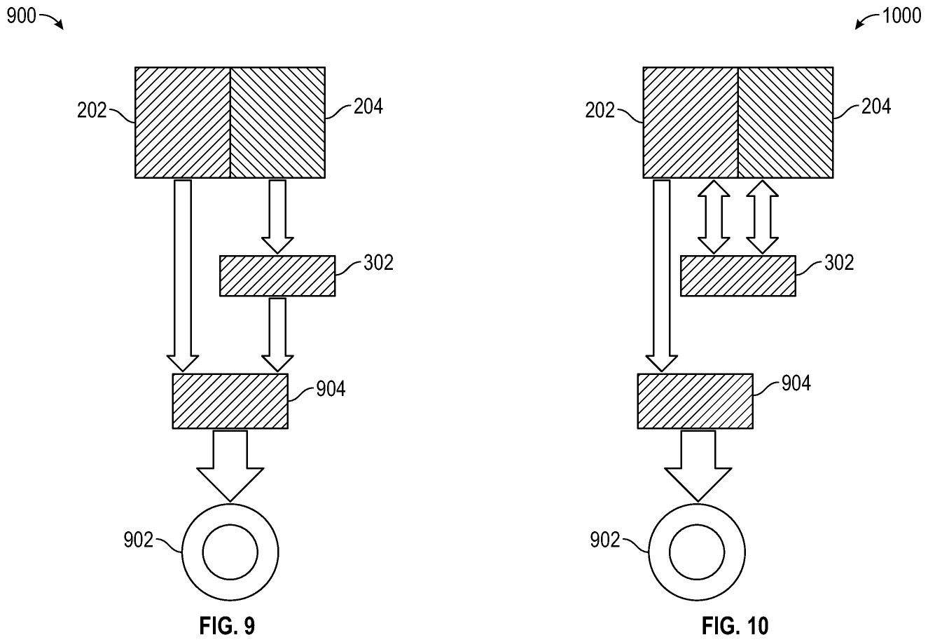

FIG. 9 shows a diagram 900 indicating use of the first cell and second cell to operate a motor 902 in a propulsion mode. The first cell 202 is connected to the motor 902 via the inverter 904. The DC/DC converter 302 is used to couple second cell 204 to the inverter 904, thus allowing power from the second cell to be used at the motor 902.

FIG. 10 shows a diagram 1000 indicating operation of the motor 902 in a heating mode. The first cell 202 is connected to the motor 902 via the inverter 904. The DC/DC converter 302 is not connected to the inverter 904. Instead, the DC/DC converter 302 couples the second cell 204 to the first cell 202, thereby allowing the heating procedure disclosed herein for the first cell and the second cell to be performed.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of heating a battery of a vehicle, comprising:
connecting a first cell of the battery to a first side of a direct current converter (DC/DC converter);
connecting a second cell of the battery to a second side of the DC/DC converter;
flowing a first current between the first cell and the second cell through the DC/DC converter to heat the first cell and the second cell during a first heating phase; and
flowing a second current between the second cell and the DC/DC converter to heat the second cell during a second heating phase.

2. The method of claim 1, wherein the DC/DC converter generates an alternating current to heat the first cell and the second cell.

3. The method of claim 1, wherein a first heating rate of the first cell is greater than a second heating rate of the second cell.

4. The method of claim 3, further comprising selecting a magnitude of the first current based on the first heating rate.

5. The method of claim 1, further comprising switching from the first heating phase to the second heating phase when a first temperature of the first cell rises to a target temperature.

6. The method of claim 1, further comprising operating the vehicle in one of a propulsion mode and a heating mode, wherein the DC/DC converter connects the second cell to a motor of the vehicle in the propulsion mode and connects the second cell to the first cell in the heating mode.

7. The method of claim 6, further comprising operating the motor off of the first cell in both the propulsion mode and the heating mode.

8. A system for heating a battery of a vehicle, comprising:
a first cell having a first cell type;
a second cell having a second cell type;
a direct current converter (DC/DC converter) having a first side coupled to the first cell and a second side coupled to the second cell; and
a processor configured to:
control flow of a first current between the first cell and the second cell through the DC/DC converter to heat the first cell and the second cell during a first heating phase; and
control flow of a second current between the second cell and the DC/DC converter to heat the second cell during a second heating phase.

9. The system of claim 8, wherein the DC/DC converter generates an alternating current to heat the first cell and the second cell.

10. The system of claim 8, wherein a first heating rate of the first cell is greater than a second heating rate of the second cell.

11. The system of claim 10, wherein the processor is further configured to select a magnitude of the first current based on the first heating rate.

12. The system of claim 8, wherein the processor is further configured to switch from the first heating phase to the second heating phase when a first temperature of the first cell rises to a target temperature.

13. The system of claim 8, wherein the processor is further configured to operate the vehicle in one of a propulsion mode and a heating mode, wherein the DC/DC converter couples the second cell to a motor of the vehicle in the propulsion mode and couples the second cell to the first cell in the heating mode.

14. The system of claim 13, wherein the processor is further configured to operate the motor off of the first cell in both the propulsion mode and the heating mode.

15. A vehicle, comprising:
a battery having a first cell having a first cell type and a second cell having a second cell type;
a direct current converter (DC/DC converter) having a first side coupled to the first cell and a second side coupled to the second cell; and
a processor configured to:
control flow of a first current between the first cell and the second cell through the DC/DC converter to heat the first cell and the second cell during a first heating phase; and
control flow of a second current between the second cell and the DC/DC converter to heat the second cell during a second heating phase.

16. The vehicle of claim 15, wherein the DC/DC converter generates an alternating current to heat the first cell and the second cell.

17. The vehicle of claim 15, wherein a first heating rate of the first cell is greater than a second heating rate of the second cell.

18. The vehicle of claim 17, wherein the processor is further configured to select a magnitude of the first current based on the first heating rate.

19. The vehicle of claim 15, wherein the processor is further configured to switch from the first heating phase to the second heating phase when a first temperature of the first cell rises to a target temperature.

20. The vehicle of claim 15, wherein the processor is further configured to operate the vehicle in one of a propulsion mode and a heating mode, wherein the DC/DC converter couples the second cell to a motor of the vehicle in the propulsion mode and couples the second cell to the first cell in the heating mode.
